(19) United States
(12) Patent Application Publication
(10) Pub. No.: US 2014/0144606 A1
(43) Pub. Date: May 29, 2014

(54) BRACKET FOR SUPPORTING ELECTRONIC DEVICE

(71) Applicant: FIH (Hong Kong) Limited, Kowloon (HK)

(72) Inventor: JHIH-JIE JIANG, New Taipei (TW)

(73) Assignee: FIH (Hong Kong) Limited, Kowloon (HK)

(21) Appl. No.: 13/952,778

(22) Filed: Jul. 29, 2013

(30) Foreign Application Priority Data
Nov. 27, 2012 (TW) 101144389

(51) Int. Cl. B60R 11/00

(52) U.S. Cl. CPC B60R 11/00
USPC 165/67

(57) ABSTRACT

A bracket for supporting an electronic device includes receiving part and a heat-radiating unit. The receiving part detachably receives the electronic device and defines a receiving groove. The head radiating unit is detachably received in the receiving groove. The heat-radiating unit comprises at least one heat dissipating element received in the receiving groove. The heat dissipating elements are positioned corresponding to heat-generating components of the electronic device. Heat generated by the heat-generating components is absorbed by the heat dissipating elements and then immediately.

### BACKGROUND

1. Technical Field

The exemplary disclosure generally relates to a bracket, and particularly to a bracket for holding and supporting an electronic device.

2. Description of Related Art

A bracket for holding and supporting an electronic device to a vehicle is widely used. The bracket can allow a user to answer a call without holding the mobile phone, read visual navigation service at a custom angle, or the like. The bracket includes a main body attached to the vehicle and a supporting element for holding an electronic device. However, if heat generated by the electronic device cannot be dissipated efficiently, the efficiency and reliability of the electronic device will be reduced.

Therefore, there is room for improvement within the art.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is an exploded view of an exemplary embodiment of a bracket for holding an electronic device.

FIG. 2 is another exploded view of the bracket in FIG. 1.

FIG. 3 is an assembled view of the bracket in FIG. 1.

FIG. 4 is an isometric view of the bracket in FIG. 3 holding an electronic device.

### DETAILED DESCRIPTION

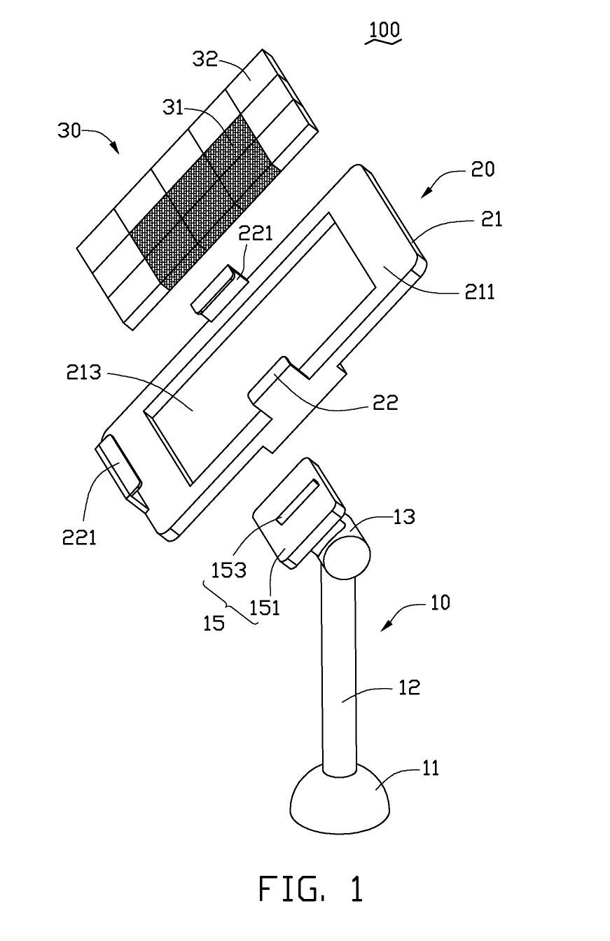

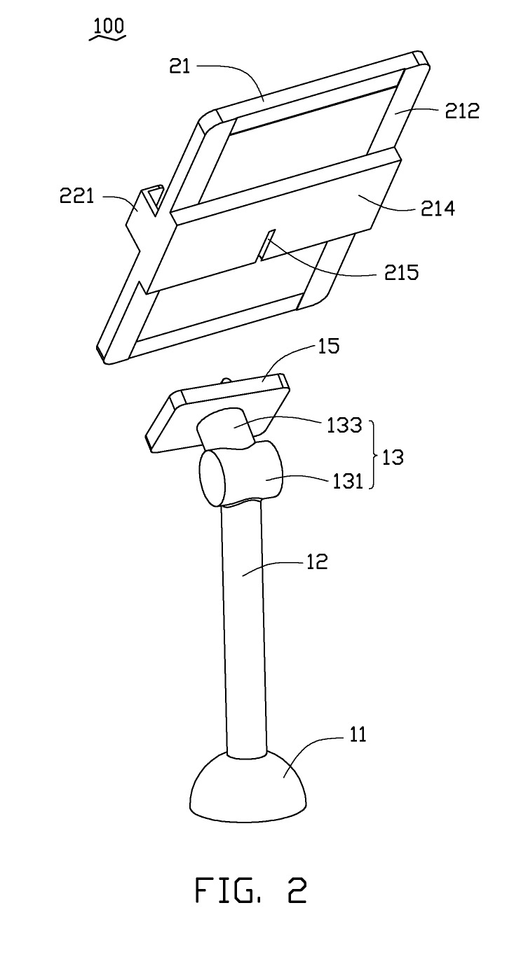

FIGS. 1-4 show an exemplary embodiment of a bracket 100 for holding and supporting an electronic device 200 in a vehicle, such as a car, a bicycle, or a motorcycle. The bracket 100 includes a base 10, a receiving part 20, and a heat-radiating unit 30. The base 10 is rotatably connected to the receiving part 20. The heat-radiating unit 30 is received by the receiving part 20. The electronic device 200 is detachably received in the receiving part 20 and contacts the heat-radiating unit 30.

The base 10 includes a fixing base 11, a supporting rod 12, a rotating element 13, and a connector 15. The fixing base 11 is configured to be securely attached to the vehicle. The supporting rod 12 and the rotating element 13 have a substantially cylindrical shape. One end of the supporting rod 12 is attached to the fixing base 11.

The rotating element 13 includes a joint member 131 and a connecting arm 133. The joint member 131 is rotatably connected to the other end of the supporting rod 12, and is perpendicularly disposed relative to an extending direction of the supporting rod 12. The connecting arm 133 is connected to the joint member 131, and forms an angle between itself and the supporting rod 12. The connecting arm 133 rotates around an axis of the joint member 131 to adjust the angle between the connecting arm 133 and the supporting rod 12. The connector 15 has a substantially rectangular shape, and connects to the connecting arm 133. The connector 15 includes a rectangular plate 151 connecting to an end of the connecting arm 133, and a latching portion 153 protruding from the sheet 151, opposite to the connecting arm 133. In the exemplary embodiment, the latching portion 153 is a latching bar.

The receiving part 20 includes a main body 21 and a clamping element 22. The main body 21 is a rectangular metal plate, and includes a fixing surface 211 and an opposite latching surface 212. The fixing surface 211 defines a receiving groove 213 therein for receiving the heat-radiating unit 30.

The main body 21 is made of thermally-conductive materials, such as graphite, metal, metal alloy, or plastic filled with thermally-conductive particles. The metal is selected from a group consisting of copper, silver, stainless steel, iron, and copper. The thermally-conductive particles are selected from a group consisting of copper, silver, stainless steel, iron, silicon dioxide, and aluminum oxide.

The latching surface 212 forms a mounting plate 214 in a middle portion of the latching surface 212. The mounting plate 214 defines a latching groove 215 therein. The latching groove 215 detachably engages with the latching portion 153.

The clamping element 22 includes a clasp 221 extending from at least two lateral sides and a bottom side adjacent to the two lateral sides of the fixing surface 211. The clasps 221 are made of elastic materials for holding the electronic devices 200 cooperatively with the main body 21. The elastic materials may be thermoplastic polyurethane elastomer, or polyethyleneterephthalate.

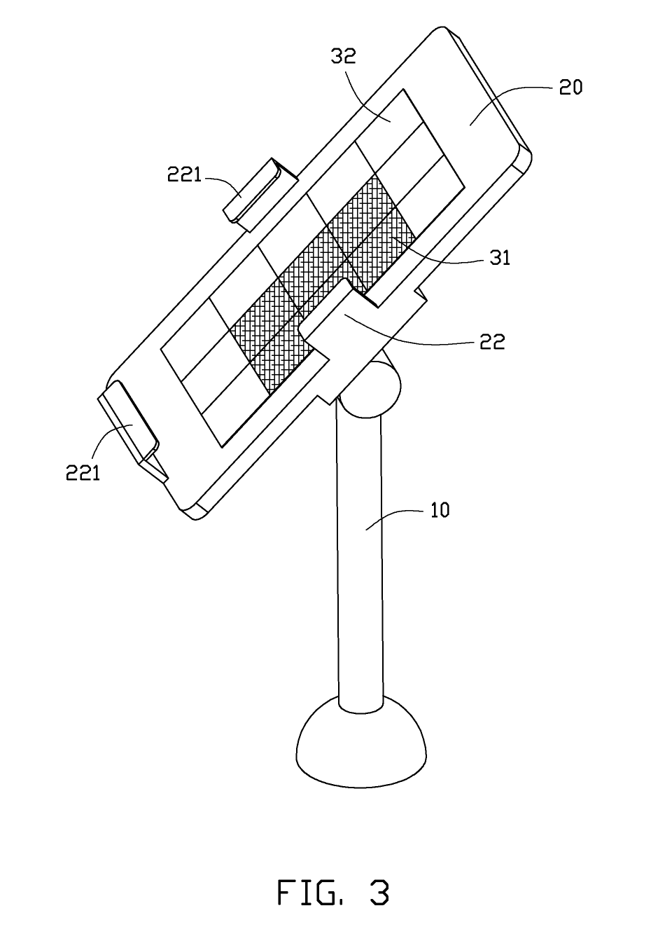

Referring to FIG. 3, the heat-radiating unit 30 includes a plurality of heat-dissipating elements 31 and a plurality of engaging elements 32. The heat-dissipating elements 31 are made of thermally-conductive materials, such as graphite, metal, metal alloy, or plastic filled with thermally-conductive particles. The metal is selected from a group consisting of copper, silver, stainless steel, iron, and copper. The thermally-conductive particles are selected from a group consisting of copper, silver, stainless steel, iron, silicon dioxide, and aluminum oxide. The engaging elements 32 are made of plastic or ceramic.

In another embodiment, the engaging elements 32 are also made of thermally-conductive materials.

The heat dissipating elements 31 are arranged according to positions of the heat generating components, such as a battery pack or a microcontroller unit, in the electronic device 200, which means positions and a number of the heat dissipating elements 31 may be different according to different electronic devices 200 held in the receiving part 20. In the exemplary embodiment, the number of the heat dissipating elements 31 is six, and the number of the engaging elements 32 is nine. The heat dissipating elements 31 and the engaging elements 32 are substantially identical in shape and size. The heat dissipating elements 31 and the engaging elements 32 are arranged in a matrix pattern and are held in the receiving groove 213 by frictional and extrusive forces therebetween.

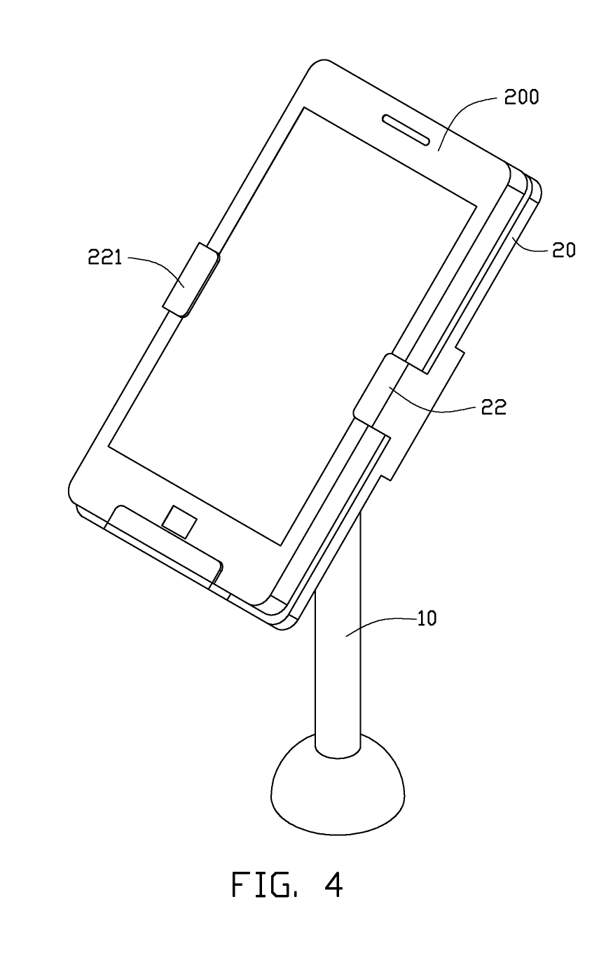

Referring to FIG. 4, the latching portion 153 is engaged in the latching groove 215 by a frictional force therebetween. Before attaching the electronic device 200 to the bracket 100, the heat-radiating unit 30 is retained in the receiving groove 213 with the heat dissipating elements 31 arranged according to heat generating portions of the electronic device 200. Then, the electronic device 200 is mounted to the receiving part 20 and clamped by the clamping elements 22, such that the electronic device 200 is in contact with the heat-radiating unit 30 and the fixing surface 211 of the main body 21. Since the heat dissipating elements 31 are arranged corresponding to the heat-generating components of the electronic device 200, heat generated by the electronic device 200 is absorbed by the heat dissipating elements 31 and then immediately transferred to the main body 21. Therefore, heat generated by the electronic device 200 is effectively dissipated. In addition, the user can adjust the viewing angle of the electronic device 200 by rotating the receiving part 20 with respect to the supporting rod 12.

In another exemplary embodiment, the heat dissipating elements 31 and the engaging element 32 fit together by sliding slot(s) and sliding rail(s). For example, sliding slot(s) are defined in sidewall(s) of the receiving groove 213 to receive sliding rail(s) formed on side(s) of the heat-radiating unit 30, thereby allowing the user to change positions of the heat dissipating elements 31 and the engaging elements 32.

It is to be understood, however, that even through numerous characteristics and advantages of the exemplary disclosure have been set forth in the foregoing description, together with details of the system and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A bracket for supporting electronic device, comprising:
a receiving part detachably receiving the electronic device therein, the receiving part defining a receiving groove, and
a heat-radiating unit comprising at least one heat dissipating element received in the receiving part and positioned corresponding to heat-generating components of the electronic device to dissipate heat generated by the electronic device.

2. The bracket of claim 1, wherein the at least one heat dissipating element of made of graphite, metal, metal alloy, or plastic filled with thermally-conductive particles.

3. The bracket of claim 2, wherein the metal is selected from a group consisting of copper, silver, stainless steel, and iron.

4. The bracket of claim 2, wherein the thermally-conductive particles are selected from a group consisting of copper, silver, stainless steel, iron, silicon dioxide and aluminum oxide.

5. The bracket of claim 1, wherein the heat-radiating unit further comprises at least one engaging element, the at least one engaging element and the at least one heat dissipating element are received in the receiving groove.

6. The bracket of claim 5, wherein the at least one engaging element is made of plastic or ceramic.

7. The bracket of claim 1, further comprising a base rotatably connected to the receiving part, wherein the base comprises a fixing base, a supporting rod, a rotating element and a connector, one end of the supporting rod is attached to the fixing base, the rotating element is rotatably connected between the other end of the supporting rod and the connector.

8. The bracket of claim 7, wherein the rotating element includes a joint member and a connecting arm, the joint member is rotatably connected to the other end of the supporting rod, and is perpendicularly disposed relative to an extending direction of the supporting rod; the connecting arm is connected to the joint member and forms an angle between itself and the supporting rod.

9. The bracket of claim 8, wherein the receiving part comprises a main body and a clamping element protruding from the main body.

10. The bracket of claim 9, wherein the main body comprises a fixing surface and an opposite latching surface, the fixing surface defines a receiving groove therein for receiving the heat-radiating unit, the latching surface has a latching groove defined therein, the latching groove detachably engages with the latching portion.

11. The bracket of claim 10, wherein the clamping element comprises clasps extending from at least two lateral sides and a bottom side adjacent to the two lateral sides of the fixing surface.

12. The bracket of claim 11, wherein the clasps are made of elastic material.
